(19) United States
(12) Patent Application Publication
(10) Pub. No.: US 2021/0409869 A1
(43) Pub. Date: Dec. 30, 2021

(54) SPEAKER EDGE, DIAPHRAGM UNIT, AND METHOD OF MANUFACTURING SPEAKER EDGE

(71) Applicant: SONY CORPORATION, TOKYO (JP)

(72) Inventors: KUNIHIKO TOKURA, TOKYO (JP); YUICHI OKA, TOKYO (JP)

(21) Appl. No.: 17/281,475

(22) PCT Filed: Aug. 8, 2019
(86) PCT No.: PCT/JP2019/031438

§ 371 Date: Mar. 30, 2021

(30) Foreign Application Priority Data
Oct. 11, 2018 (JP) 2018-192313

(51) Int. Cl. H04R 7/20; H04R 31/00; H04R 7/12; H04R 1/02

(52) U.S. Cl. CPC H04R 7/20; H04R 1/026; H04R 7/12; H04R 31/003

(57) ABSTRACT

A speaker edge includes a urethane foam that is hot press molded and an elastomer sheet that is in close contact with a surface of the urethane foam, in which the urethane foam and the elastomer sheet are resins of the same type.

### TECHNICAL FIELD

The present technology relates to a speaker edge, a diaphragm unit, and a method of manufacturing the speaker edge.

### BACKGROUND ART

In recent years, a portable speaker equipped with an amplifier, a battery, and Bluetooth (registered trademark) inside has been used so that music via a smartphone can be enjoyed outdoors. When a portable speaker is used in a place such as a bathroom or beach, the speaker needs to have high waterproofness (for example, JIS standard IPX7). A conventional portable speaker that satisfies IPX7 has used film for a diaphragm and rubber for a speaker edge. However, the rubber speaker edge is relatively high in weight and hard, which has caused a reduction in the sound pressure and deterioration in the sound quality of the portable speaker.

On the other hand, there has been proposed an example that has worked on reducing the weight and increasing the softness of the speaker edge by using a urethane foam or the like as the material of the speaker edge. Patent Document 1 describes that the speaker edge is made to have heat resistance, weather resistance, oil resistance, and waterproofness by coating a surface of a polyether or polyester urethane foam with a hot-melt acrylic resin to form a film.

### CITATION LIST

### Patent Document

Patent Document 1: Japanese Patent No. 2900417

### SUMMARY OF THE INVENTION

### Problems to be Solved by the Invention

In order for the portable speaker to be used at the beach or in the bathroom, the speaker needs to have high waterproofness (IPX7). However, the speaker edge described in Patent Document 1 is made by press-molding a soft urethane foam that originally has a thickness of 8 mm, and thus cannot be said to be lightweight and has not been satisfactory in terms of the sound pressure. In addition, it has been difficult to satisfy the IPX7 waterproof standard due to slight breathability.

Therefore, an object of the present technology is to provide a speaker edge, a diaphragm unit, and a method of manufacturing the speaker edge, the speaker edge being lightweight and soft, having excellent characteristics and high waterproofness, and being lightweight and soft.

### Solutions to Problems

The present technology is a speaker edge including a urethane foam that is hot press molded and an elastomer sheet that is in close contact with a surface of the urethane foam, in which

the urethane foam and the elastomer sheet are resins of the same type.

Moreover, the present technology is a diaphragm unit including:

the speaker edge described above; and

a diaphragm that is stuck to an inner peripheral portion of the speaker edge and has waterproof performance.

Furthermore, the present technology is a method of manufacturing a speaker edge, the method including:

making a urethane foam by hot press molding a urethane foam sheet; and

placing an elastomer sheet on the polyurethane foam and heat sealing the polyurethane foam and the elastomer sheet.

### Effects of the Invention

According to at least one embodiment, the speaker edge of the present technology can realize a speaker that is lightweight and soft and has favorable characteristics while having high waterproofness. Note that the present technology may have an effect not necessarily limited to the one described herein but any effect described in the present technology or an effect different therefrom.

### BRIEF DESCRIPTION OF DRAWINGS

FIG. 1 is a cross-sectional view of a speaker unit in one embodiment.

FIG. 2A is a top view of a diaphragm unit in one embodiment, and FIG. 2B is a cross-sectional view of FIG. 2A.

FIG. 3 is a cross-sectional view illustrating details of a speaker edge in one embodiment.

FIGS. 4A to 4D are cross-sectional views for explaining a method of manufacturing a speaker edge in one embodiment.

FIG. 5 is a graph regarding a relationship between a displacement of the speaker edge and force in one embodiment.

FIG. 6 is a graph of frequency characteristics of a speaker using the speaker edge in one embodiment (example) and a speaker using a conventional speaker edge (comparative example).

### MODE FOR CARRYING OUT THE INVENTION

Embodiments and the like of the present technology will now be described with reference to the drawings. Note that the description will be made in the following order.

<1. One embodiment>

<2. Variation>

Embodiments and the like described below are specific examples preferred in the present technology, the content of which is not to be limited to these embodiments and the like.

Also, for brevity of illustration, the following description includes a case where reference numerals are given to only some configurations or a case where some configurations are illustrated in a simplified manner.

### 1. One Embodiment

“Configuration of Speaker Unit”

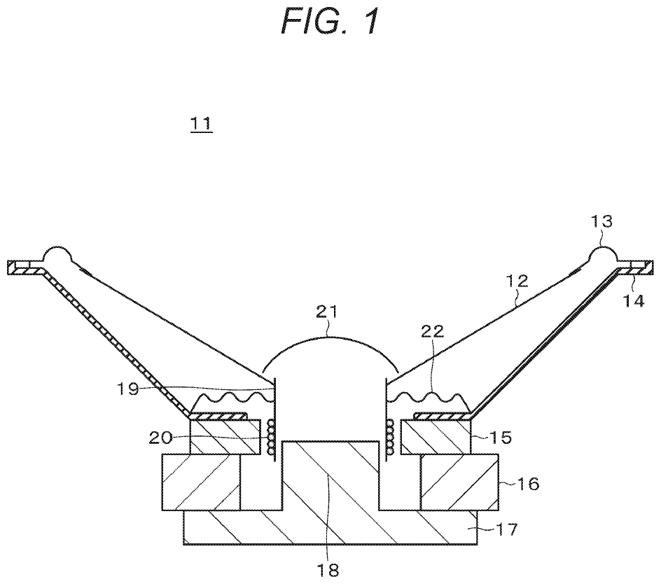

Hereinafter, one embodiment of the present technology will be described in detail. FIG. 1 is a cross-sectional view of a speaker unit 11 according to one embodiment of the present technology. The speaker unit 11 includes a diaphragm 12 that is cone-shaped. An outer peripheral portion of the diaphragm 12 is fixed to an inner peripheral portion of a speaker edge 13 so that the diaphragm 12 is supported by the speaker edge 13. An outer peripheral portion of the speaker edge 13 is fixed to a frame 14.

A plate 15 including a magnetic material is attached to the frame 14. The plate 15 is formed in a substantially annular shape. A magnet 16 formed in an annular shape is attached to a rear surface (a lower side in the figure) of the plate 15. A yoke 17 is attached to a rear surface (a lower side in the figure) of the magnet 16.

The plate 15, the magnet 16, and the yoke 17 are joined together while their central axes are aligned. A coil bobbin 19 is supported on a center pole portion 18 of the yoke 17 so as to be displaceable (movable) in a front-rear direction, that is, in an axial direction (a vertical direction in the figure) of the center pole portion 18. The coil bobbin 19 is formed in a cylindrical shape, and a front end of the coil bobbin 19 is fixed to the diaphragm 12. A voice coil 20 is wound around an outer peripheral surface of the coil bobbin 19.

At least a part of the voice coil 20 is located in a magnetic gap. Since the voice coil 20 is located in the magnetic gap, the plate 15, the magnet 16, the yoke 17, and the voice coil 20 form a magnetic circuit. When a drive signal is supplied to the voice coil 20, the diaphragm 12 and the voice coil 20 are displaced.

A cap 21 is bonded to a central portion of the diaphragm 12 and prevents foreign matter such as dust from entering the voice coil 20. The cap 21 includes the same material as the diaphragm 12. A damper 22 is connected to the coil bobbin 19 to support the coil bobbin 19 in a manner that allows for normal vibration, and serves a function of holding a center position when at rest.

When a drive voltage or drive current is supplied to the voice coil 20 of the speaker unit 11 configured as described above, thrust is generated in the magnetic circuit so that the coil bobbin 19 supported by the damper 22 is displaced in the front-rear direction (the axial direction or the vertical direction in the figure), and that the diaphragm 12 vibrates with the displacement of the coil bobbin 19. At this time, a sound proportional to the voltage or current is output.

### One Embodiment of the Present Technology

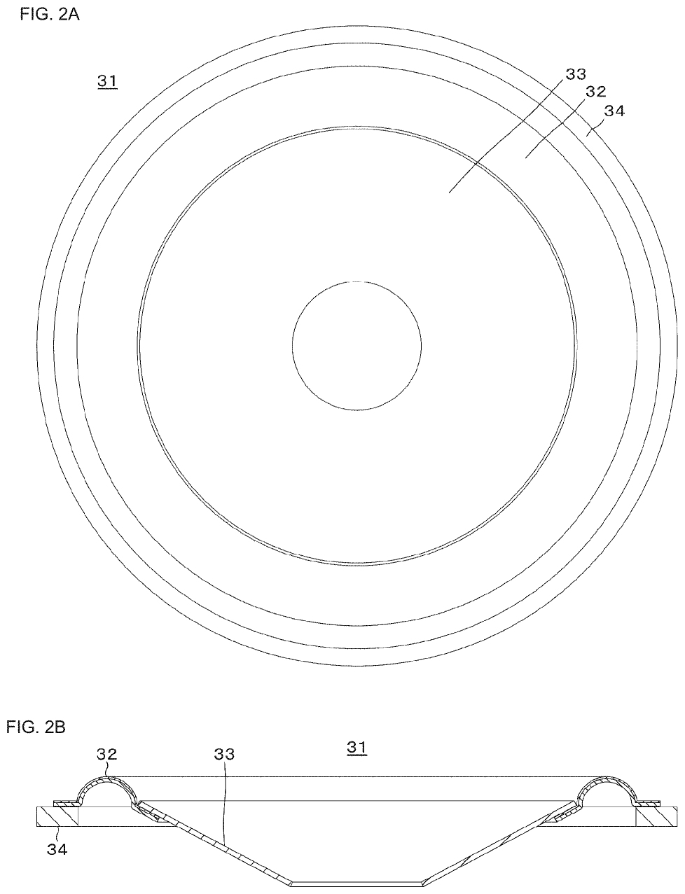

One embodiment of the present technology will be described with reference to the drawings. FIGS. 2A and 2B illustrate a top view and a cross-sectional view of a diaphragm unit 31 according to one embodiment of the present technology, respectively. The diaphragm unit 31 includes a speaker edge 32, a diaphragm 33, and a gasket 34 as a support. The speaker edge 32 and the gasket 34 each have a substantially annular shape when viewed from a top surface. The diaphragm 33 is bonded to, for example, a surface of an inner peripheral portion of the speaker edge 32, and the gasket 34 is bonded to an outer peripheral portion of the speaker edge 32.

The diaphragm 33 is cone-shaped and has waterproof performance. The material of the diaphragm 33 is, for example, foamed mica that has been waterproofed, paper laminated with a film, or plastic. The foamed mica is a multi-cellular structure obtained by heating a paper article including fine mica flakes, pulp fibers, and polyvinyl alcohol fibers. The gasket 34 includes rubber or paper. When the gasket 34 is fixed to a frame (not shown) of the speaker unit, the diaphragm unit 31 is supported by the frame. The diameters of the speaker edge 32, the diaphragm 33, and the gasket 34 are, for example, 35 mm to 70 mm.

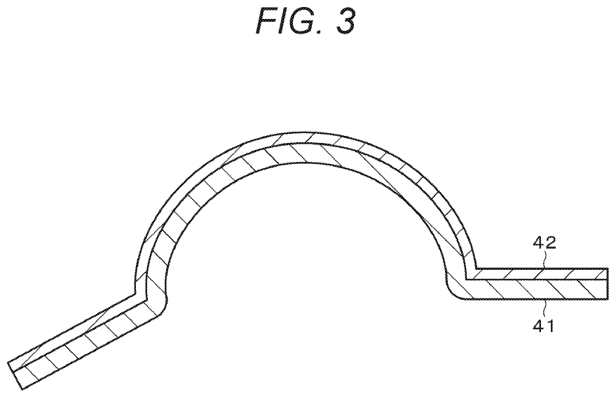

FIG. 3 illustrates an enlarged cross section of a part of the speaker edge 32. A straight portion on the left side of FIG. 3 corresponds to a center side of the speaker and a side to which the diaphragm 33 is bonded. A straight portion on the right side of FIG. 3 corresponds to an edge side of the speaker and a side to which the gasket 34 is fixed. The speaker edge 32 has a two-layer structure as a whole, and a central portion thereof has a substantially semicircular shape.

The speaker edge 32 includes a lightweight and soft material. A back side (a side of a rear surface of the speaker, or a lower side in FIG. 3) (first layer) of the speaker edge 32 includes, for example, a polyether urethane foam 41. A front side (a side of a front surface of the speaker, or an upper side in FIG. 3) (second layer) of the speaker edge 32 includes a urethane elastomer sheet 42 including resin of the same type (polyether-based). Other resins of the same type include polyester and olefin.

The polyether urethane elastomer sheet 42 covers the entire area of a front side of the polyether urethane foam 41. The two layers of the polyether urethane foam 41 and the polyether urethane elastomer sheet 42 have different structures but are substances of chemically the same type, and thus can be brought into close contact with each other well even if an adhesive layer is omitted between the two layers, and are stuck together by heat sealing. Moreover, the two layers expand and contract together to be able to prevent water leakage even under pressure of immersion at the depth of 1 m.

A surface of the polyether urethane foam 41 is coated with a water-repellent material. The polyether urethane elastomer sheet 42 has high waterproofness by itself, and is heat-sealed to the front side of the polyether urethane foam 41 such that the speaker edge 32 can satisfy the waterproof standard of IPX7. The thickness of the polyether urethane foam 41 is about 0.2 mm to about 0.4 mm, and the thickness of the polyether urethane elastomer sheet 42 is about 0.05 mm.

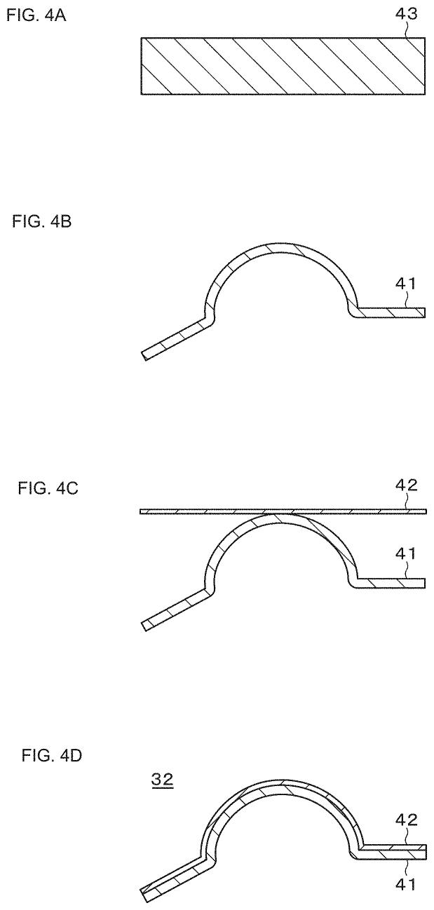

The polyether urethane foam 41 is compressed when molded as the speaker edge 32. The polyether urethane foam 41 having the thickness of about 0.2 mm to about 0.4 mm is obtained by compressing a polyether urethane foam sheet 43 (see FIG. 4) having a density of about 0.28 g/cm³ and a thickness of about 4 mm. The compression ratio from the polyether urethane foam sheet 43 to the polyether urethane foam 41 is about 1/20 or more and about 1/10 or less. Since the surface area of a main surface of the polyether urethane foam sheet 43 and the polyether urethane foam 41 is substantially the same before and after molding, the polyether urethane foam 41 after molding has substantially the same weight as the polyether urethane foam sheet 43 having substantially the same surface area thereas.

A member obtained by hot press molding the polyether urethane foam of Patent Document 1 mentioned at the beginning is described as a product obtained by compressing the polyether urethane foam having a density of 35 kg/m³ (0.35 g/cm³) and a thickness of 8 mm, and therefore the polyether urethane foam sheet 43 or the polyether urethane foam 41 of the present technology is lighter than the one described in Patent Document 1.

The polyether urethane elastomer sheet 42 is relatively small in thickness and thus does not significantly affect the hardness of the speaker edge 32. The speaker edge 32 has, for example, an elastic modulus on the order of 10⁶ Pa (for example, when the number of significant figures is two digits, the elastic modulus is 1.0×10⁶ Pa or more and less than 1.0×10⁷ Pa), and is softer than a conventional rubber speaker edge.

“Method of Manufacturing Speaker Edge”

Next, a method of manufacturing the speaker edge 32 will be described. FIG. 4 illustrates an example of a process of manufacturing the speaker edge 32. As illustrated in FIG. 4A, the polyether urethane foam sheet 43 having the density of 0.28 g/cm³ was prepared, and the polyether urethane foam sheet 43 was coated with a water-repellent material. In order to keep a stiffness value (described later) low, the thickness of the polyether urethane foam sheet 43 in FIG. 4A was set to about 4 mm.

Next, the polyether urethane foam sheet 43 in FIG. 4A was compression-molded by pressing it for 15 seconds with a mold heated to 200° C., and as illustrated in FIG. 4B, the polyether urethane foam 41 having a substantially semicircular cross section and the thickness of about 0.2 mm or more and about 0.4 mm or less (thickness of about 1/20 or more and about 1/10 or less the thickness before pressing) is made.

Then, as in FIG. 4C, the polyether urethane elastomer sheet 42 (a waterproof soft sheet) having the thickness of about 0.05 mm was placed on the front side (an upper side in FIG. 4B) of the polyether urethane foam 41 so as to cover the polyether urethane foam 41.

The polyether urethane foam 41 and the polyether urethane elastomer sheet 42 were heat-sealed by pressing with the temperature of the mold on the side of the polyether urethane elastomer sheet 42 (an upper side in FIG. 4C) set to 130° C. and the temperature of the mold on the side of the polyether urethane foam 41 (a lower side in FIG. 4C) set to 60° C. After taken out of the molds, it was allowed to cool for several hours, and the speaker edge 32 as in FIG. 4D was made.

### Example

Hereinafter, the present technology will be specifically described on the basis of an example using the speaker edge 32. Note that the present technology is not limited to the example described below.

### Example

The speaker edge 32 used has the configuration described in “Details of speaker edge” (for example, the shape illustrated in FIGS. 2 and 3) and is manufactured by the manufacturing method described in “Method of manufacturing speaker edge” (for example, the manufacturing process illustrated in FIG. 4). The diaphragm 33 having the shape in FIG. 2 was used. The material of the diaphragm 33 is foamed mica. As illustrated in FIG. 2B, the diaphragm 33 was stuck to the front side (upper side in FIG. 2B) of the speaker edge.

### Comparative Example

As a comparative example, a rubber speaker edge was used. The shape of the speaker edge and the diaphragm are the same as those in the example. The rubber is one obtained by vulcanization of acrylonitrile butadiene rubber (NBR) with a hardness of A50°.

[Evaluation of Weight and Resonance Frequency]

The weight of the speaker edge and the bass resonance frequency of the speaker edge with the diaphragm stuck thereto were measured. The results are illustrated in Table 1.

TABLE 1

| | EXAMPLE | COMPARATIVE EXAMPLE |
|---|---|---|
| WEIGHT (g) | 0.85 | 1.97 |
| BASS RESONANCE | 96 | 90 |
| FREQUENCY (Hz) | | |

As illustrated in Table 1, the weight of the example is about half that of the comparative example, but the bass resonance frequency was almost the same in the example and the comparative example. The bass resonance frequency “f0”, stiffness “S” of a vibration system, and mass “M” of the vibration system have a relationship represented by the following expression.

f0=½π×(S/M)^{1/2} (Hz)

In the example and the comparative example, “f0” is almost the same, and the weight of the example is lighter than (about half) that of the comparative example. Therefore, it can be seen that “S” of the example is lower than that of the comparative example (the speaker edge of the example is softer than that of the comparative example). The example is sufficiently low in stiffness and easy to move. Therefore, the speaker edge of the example is more lightweight and softer than that of the comparative example.

### [Evaluation of Linearity]

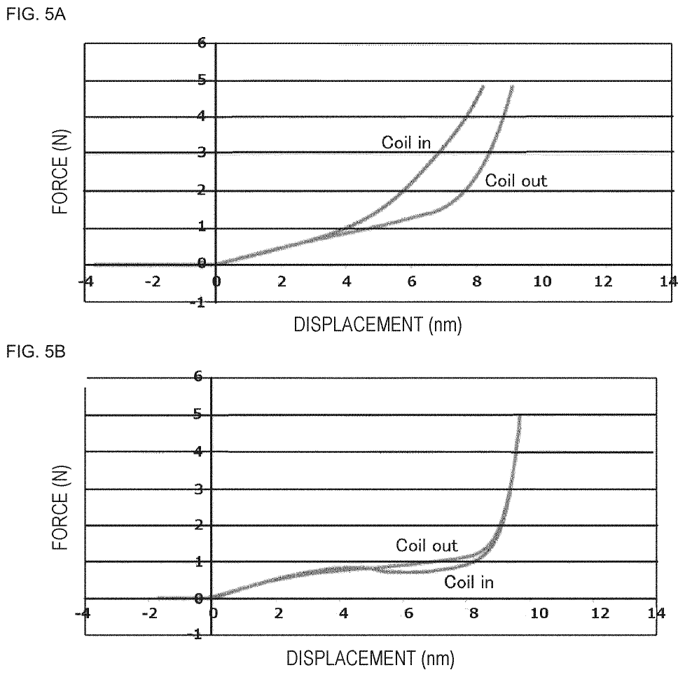

The vibration system with the speaker edge stuck to the diaphragm was set on a jig, and a relationship between displacement and force was measured using a load cell that causes displacement at a constant speed. The results are illustrated in FIG. 5.

FIG. 5A corresponds to the comparative example, and FIG. 5B corresponds to the example. In FIG. 5, “Coil in” indicates the time when the vibration system moves toward the rear of the speaker (or when it moves toward the lower side in FIG. 1 or FIG. 2B), and “Coil out” indicates the time when it moves toward the front of the speaker (or when it moves toward the upper side in FIG. 1 or FIG. 2B). From FIG. 5, it can be seen that the example has lower stiffness than the comparative example because slopes of the lines are smaller than those of the comparative example. Moreover, “Coil in” and “Coil out” match more in the example than in the comparative example, and the interval where the curvature is approximately zero is longer in the example than in the comparative example, whereby it can be seen that the example has better linearity, that is, better sound quality, than the comparative example.

### [Evaluation of Frequency Characteristics of Speaker]

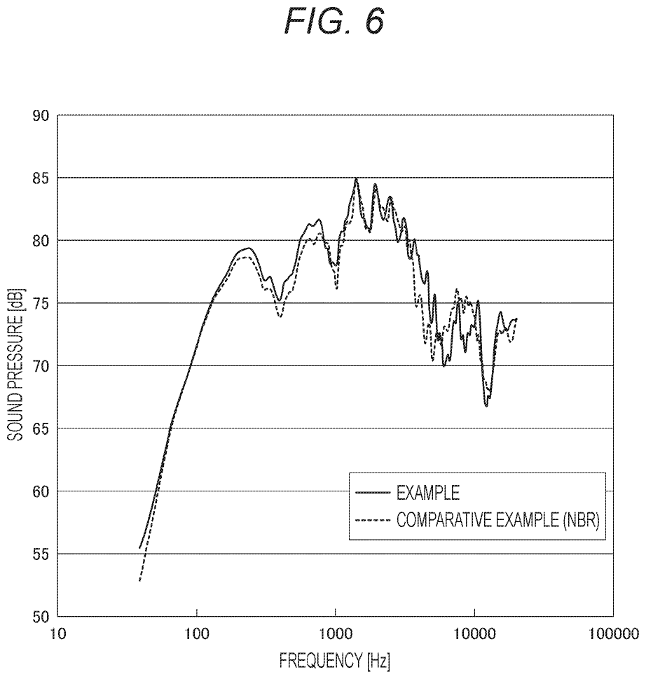

The speaker unit as in FIG. 1 was made using the speaker edge, and frequency characteristics of the speaker were determined. The results are illustrated in FIG. 6.

As illustrated in FIG. 6, the sound pressure of the example was about 1 dB to about 1.5 dB higher in the audible band than that of the comparative example. From this result, it was found that the sound pressure of the examples has been improved compared to that of the comparative example. Moreover, in the bass range, the example almost coincided with the comparative example. Although the speaker edge of the example is lightweight, it was found that the speaker edge of the example can reproduce the bass range as much as a conventional product (the comparative example).

### [Evaluation of 1-m Immersion Waterproofness]

A waterproof performance of the vibration system of the example (the speaker edge and the diaphragm and the like stuck together) was tested. The vibration system was attached to a surface of an immersion box with a volume of 300 cc so that water would not leak from areas other than the surface of the speaker edge and the diaphragm. The immersion box to which the vibration system of the example was attached was submerged in the bottom of a water tank having a depth of 1 m, and this was continued for 30 minutes.

IPX7 is the JIS standard for the waterproof performance. The JIS standard stipulates a test method for IPX7 that no infiltration of water occurs even after submersion in water for 30 minutes at a depth of 15 cm to 1 m below the surface of the water.

As a result of the waterproof performance test, it was confirmed that the speaker edge 32 was stretched by water pressure, but no water leakage occurred particularly from the surface layer. From this result, it was found that the speaker edge 32 of the example satisfies the JIS standard IPX7.

As described above, in the configuration using the speaker edge 32 of the example that is more lightweight and softer than the comparative example, the resonance frequency being almost the same as that of the comparative example was reproduced. It was found that the speaker unit equipped with the speaker edge 32 of the example has the sound pressure of about 1 to about 1.5 dB higher in the audible band than the one equipped with the conventional product, has the same level of reproduction capability in the bass range as the one equipped with the conventional product, has improved linearity, and has the waterproof performance of IPX7. Therefore, the speaker edge 32 of the example has advantages of the increased sound pressure and improved sound quality as compared with the conventional product (comparative example), and also has high waterproofness satisfying IPX7.

### 2. Variation

Although one embodiment of the present technology has been specifically described above, the content of the present technology is not limited to the above embodiment but can be modified in various ways based on the technical idea of the present technology. For example, the speaker edge 32 included the polyether urethane elastomer sheet 42 on the front side and the polyether urethane foam 41 on the back side, but may have a configuration in which the front and back are reversed. In the example and FIG. 2, the diaphragm 33 was stuck to the front side of the speaker edge 32, but may be stuck to the back side as in FIG. 1. The diaphragm 34 had the cone shape but may have a flat shape or another shape. The top view of the speaker edge 32 and the gasket 34 in FIG. 2 had the substantially annular shape, but may have a shape such as an elliptical ring, a rectangle, or another shape. The cross section of the speaker edge 32 had the substantially semicircular shape at the center, but may have another shape. The diaphragm unit 31 included only one speaker edge 32, but may include two speaker edges such as a double edge.

The present technology can have the following configurations.

(1)

A speaker edge including a urethane foam that is hot press molded and an elastomer sheet that is in close contact with a surface of the urethane foam, in which

the urethane foam and the elastomer sheet are resins of the same type.

(2)

The speaker edge according to (1), in which the resins of the same type are each any one of a polyether resin, a polyester resin, and an olefin resin.

(3)

The speaker edge according to (1) or (2), in which the urethane foam is coated with a water-repellent material.

(4)

The speaker edge according to any one of (1) to (3), in which a thickness of the urethane foam is about 0.2 mm to about 0.4 mm, and

a thickness of the elastomer sheet is about 0.05 mm.

(5)

The speaker edge according to any one of (1) to (4), in which a support including rubber or paper is arranged on an outer peripheral portion of the speaker edge, so that the speaker edge is attached to a frame of a speaker unit with the support sandwiched in between.

(6)

A diaphragm unit including:

the speaker edge of (1); and

a diaphragm that is stuck to an inner peripheral portion of the speaker edge and has waterproof performance.

(7)

A method of manufacturing a speaker edge, the method including:

making a urethane foam by hot press molding a urethane foam sheet; and

placing an elastomer sheet on the polyurethane foam and heat sealing the polyurethane foam and the elastomer sheet.

### REFERENCE SIGNS LIST

11 Speaker unit
12 Diaphragm
13 Speaker edge
14 Frame
15 Plate
16 Magnet
17 Yoke
18 Center pole portion
19 Coil bobbin
20 Voice coil
21 Cap
22 Damper
31 Diaphragm unit
32 Speaker edge
33 Diaphragm
34 Gasket
41 Polyether urethane foam
42 Polyether urethane elastomer sheet
43 Polyether urethane foam sheet

1. A speaker edge comprising a urethane foam that is hot press molded and an elastomer sheet that is in close contact with a surface of the urethane foam, wherein
the urethane foam and the elastomer sheet are resins of a same type.

2. The speaker edge according to claim 1, wherein the resins of the same type are each any one of a polyether resin, a polyester resin, and an olefin resin.

3. The speaker edge according to claim 1, wherein the urethane foam is coated with a water-repellent material.

4. The speaker edge according to claim 1, wherein a thickness of the urethane foam is about 0.2 mm to about 0.4 mm, and
a thickness of the elastomer sheet is about 0.05 mm.

5. The speaker edge according to claim 1, wherein a support including rubber or paper is arranged on an outer peripheral portion of the speaker edge, so that the speaker edge is attached to a frame of a speaker unit with the support sandwiched in between.

6. A diaphragm unit comprising:
the speaker edge according to claim 1; and
a diaphragm that is stuck to an inner peripheral portion of the speaker edge and has waterproof performance.

7. A method of manufacturing a speaker edge, the method comprising:
making a urethane foam by hot press molding a urethane foam sheet; and
placing an elastomer sheet on the polyurethane foam and heat sealing the polyurethane foam and the elastomer sheet.
